(19) United States
(12) Patent Application Publication
(10) Pub. No.: US 2021/0129432 A1
(43) Pub. Date: May 6, 2021

(54) ADDITIVE MANUFACTURING DEVICES AND METHODS

(71) Applicant: HEWLETT-PACKARD DEVELOPMENT COMPANY, L.P., Spring, TX (US)

(72) Inventors: Sergio Gonzalez, Sant Cugat del Valles (ES); Jordi Gonzalez Rogel, Sant Cugat del Valles (ES); Alex Carruesco Llorens, Sant Cugat del Valles (ES)

(21) Appl. No.: 16/605,056

(22) PCT Filed: Dec. 20, 2017
(86) PCT No.: PCT/US2017/067738

§ 371 Date: Oct. 14, 2019

(51) Int. Cl. B29C 64/176; B29C 64/393; B29C 64/165; B29C 64/307; B33Y 10/00; B33Y 30/00; B33Y 50/02

(52) U.S. Cl. CPC B29C 64/176; B29C 64/393; B29C 64/165; B33Y 50/02; B33Y 10/00; B33Y 30/00; B29C 64/307

(57) ABSTRACT

A device comprising an execution component to execute an additive printing task to create a first article and a second article, and a monitoring component to, during execution of the additive printing task, monitor a quantity of consumable resources used to create the first article.

### BACKGROUND

Additive manufacturing techniques such as three-dimensional (3D) printing relate to techniques for making 3D objects of almost any shape from a digital 3D model through additive processes in which 3D objects are generated on a layer-by-layer basis under computer control. A large variety of additive manufacturing technologies have been developed differing in build materials, deposition techniques and processes by which the 3D object is formed from the build material. Such techniques may range from applying ultraviolet light to photopolymer resin, to melting semi-crystalline thermoplastic materials in powder form, to electron-beam melting of metal powders.

Additive manufacturing processes may begin with a digital representation of a 3D object or objects to be manufactured. This digital representation may be virtually sliced into layers by computer software or may be provided in pre-sliced format. Each layer represents a cross-section of the objects to be manufactured, and is sent to an additive manufacturing apparatus (also termed a “3D printer”) where it is built upon a previously built layer. This process is repeated until the objects are completed, thereby building the objects layer-by-layer. While some available technologies directly print material, others use a recoating process to form successive layers that can then be selectively solidified in order to create each cross-section of the objects.

The build material from which the object or objects are manufactured may vary depending on the manufacturing technique and may comprise powder material, paste material, slurry material or liquid material. The build material may be provided in a source container from where it needs to be transferred to the building area or building compartment (e.g. chamber) of the additive manufacturing apparatus where the actual manufacturing takes place.

### BRIEF DESCRIPTION OF DRAWINGS

Examples will now be described, by way of non-limiting example, with reference to the accompanying drawings, in which:

FIG. 1 is a simplified schematic of an example of an additive manufacturing device;

FIG. 2 is a simplified schematic of an example of an additive manufacturing device;

FIG. 3 is a flow chart of an example of an additive manufacturing method;

FIG. 4 is a flow chart of an example of an additive manufacturing method;

FIG. 5 is a flow chart of an example of an additive manufacturing method; and

FIG. 6 is a flow chart of an example of an additive manufacturing method.

### DETAILED DESCRIPTION

Three-dimensional objects can be generated using additive manufacturing techniques. The objects may be generated by solidifying portions of successive layers of build material. In some examples, the build material can be powder-based and the properties of generated objects may be dependent on the type of build material and the type of solidification. In some examples the build material may be formed from, or may include, short fibres that may, for example, have been cut into short lengths from long strands or threads of material. The build material may in some examples include one or more plastics, ceramic, metal powders, and powder-like materials.

In some examples, solidification of the build material is enabled using a liquid solidification agent such as for example a fusing or binding agent. In further examples, solidification may be enabled by temporary application of energy to the build material. In certain examples, fusing and/or binding agents are applied to build material, wherein a fusing agent is a material that, when a suitable amount of energy is applied to a combination of build material and fusing agent, causes the build material to fuse and solidify. In some examples, a detailing agent may be applied to areas containing build material adjacent to an object being created, for example, so as to inhibit solidification of build material in these areas, or in some examples to provide a cooling effect to certain areas of build material. In other examples, other build materials and other methods of solidification may be used. In certain examples, the build material includes paste material, slurry material or liquid material.

In one example the build material in the source container is powder that has an average volume-based cross sectional particle diameter size of between approximately 5 and approximately 400 microns, between approximately 10 and approximately 200 microns, between approximately 15 and approximately 120 microns or between approximately 20 and approximately 80 microns. Other examples of suitable, average volume-based particle diameter ranges include approximately 5 to approximately 80, or approximately 5 to approximately 35 microns. In this disclosure a volume-based particle size is the size of a sphere that has the same volume as the powder particle. With “average” it is intended to explain that most of the volume-based particle sizes in the container are of the mentioned size or size range but that the container may also contain particles of diameters outside of the mentioned range. For example, the particle sizes may be chosen to facilitate distributing build material layers having thicknesses of between approximately 10 and approximately 500 microns, or between approximately 10 and approximately 200 microns, or between approximately 15 and approximately 150 microns. One example of an additive manufacturing system may be pre-set to distribute build material layers of approximately 90 microns using build material containers that contain powder having average volume-based particle diameters of between approximately 40 and approximately 60 microns. For example the additive manufacturing apparatus can be reset to distribute different layer thicknesses.

Suitable powder-based build materials for the container of this disclosure include at least one of polymers, crystalline plastics, semi-crystalline plastics, polyethylene (PE), polylactic acid (PLA), acrylonitrile butadiene styrene (ABS), amorphous plastics, Polyvinyl Alcohol Plastic (PVA), Polyamide, thermo(setting) plastics, resins, transparent powders, colored powders, metal powder, ceramics powder such as for example glass particles, and/or a combination of at least two of these or other materials wherein such combination may include different particles each of different materials or different materials in a single compound particle. Examples of blended build materials include alumide, which may include a blend of aluminum and polyamide, multi-color powder, and plastics/ceramics blends.

In some examples of additive manufacturing, it may be the case that build materials become heated. For example, where fusing agents are applied and caused to absorb energy, this tends to heat the build material, in particular in the regions to which fusing agents have been applied. This may result in solidification of portions of build material where the fusing agent has been applied. In addition, some additive manufacturing processes may pre-heat build materials, or may comprise exothermic chemical reactions or the like.

In some examples of additive manufacturing, binding agents may be applied to portions of a layer of build material. This may cause the portions of build material to solidify due to a binding process, and may in some examples occur without heat being applied to the layer of build material. Alternatively, use of a binding agent may also include application of heat to dry and/or cure the binding agent without causing the build material to melt.

An additive manufacturing apparatus such as a 3D printer may create one or more objects within a build chamber during a 3D printing task. That is, for example, as layers of build material are built up in a build chamber of the apparatus, agents may be applied to the layers so as to create one object or multiple objects in the build chamber. At the end of the manufacturing operation, the objects (also referred to as parts, articles or items) may be removed from the compartment, and unfused build material may also be removed.

It may be useful for a user of the additive manufacturing apparatus to be able to determine the amount of materials used to create each individual part during a manufacturing operation that creates multiple parts. For example, it may be useful for the user to determine the amount of build material and/or agents such as fusing, binding and/or detailing agents used to create a part. This information could be used, for example, to determine the cost of materials used to create a part.

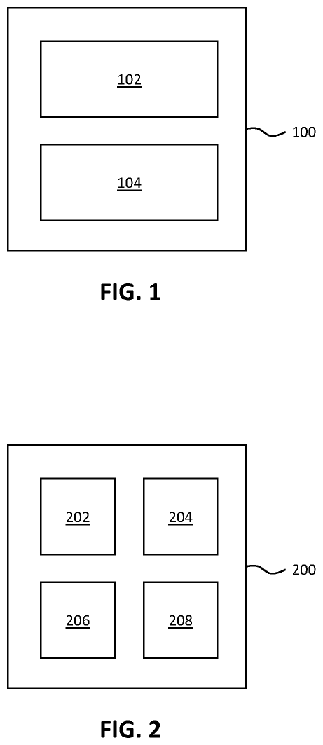

FIG. 1 is a schematic drawing of an example of a device 100 such as for example an additive manufacturing device, or a 3D printer. The device 100 comprises an execution component 102 to execute an additive printing task to create a first article and a second article. The execution component may comprise, for example, manufacturing components, build material deposition components, print agent application components, control components and/or any other suitable components. The device 100 also comprises a monitoring component 104 to, during execution of the additive printing task, monitor a quantity of consumable resources used to create the first article. This monitoring may be performed whilst the first and second article are being created. An indication of the quantity (e.g. amount) of consumable resources, which may be materials such as build material and/or print agent, may be provided upon completion of the additive printing task, and/or a cumulative total may be provided during the creation process.

In some examples, the articles are created by depositing layers of build material, and applying print agent or print agents to selected portions of the layer, to cause or control solidification (e.g. binding or fusion) of those portions accordingly. As such, a layer of build material can be used to form a layer of one or more articles or objects. In some examples, when print agents are being applied to selected portions of the layer of build material, the monitoring component 104 may attribute each portion to a particular object, and may also determine an amount of build material in that portion and/or print agent applied to that portion. As a result, the monitoring component may calculate a total amount of build material and/or print agents used to create a particular object. In some examples, print agent may be applied to portions of the layer of build material that do not form portions of a layer of objects being created. For example, detailing agents may be applied to portions of build material that do not form portions of the objects. For example, detailing agents may be applied to portions of build material that surround a particular object. Therefore, the monitoring component 104 may also calculate amounts of print agents used to create a particular object including the amount of print agent used on portions of build material that do not form portions of objects.

In some examples, before starting the additive manufacturing process or task (e.g. additive printing task), a unique identifier is assigned to each part to be created in the process. The parts may be specified for example in an additive manufacturing instruction file, such as for example a 3D Manufacturing Format (3MF) file, prior to commencement of the process. In some examples, in a stage in the manufacturing process, a virtual representation of the build chamber is separated into a plurality of voxels, each voxel indicating the presence or absence of a solid portion of an object model, and may in some examples indicate the properties of that solid portion, such as for example colour, electrical conductivity, elasticity and/or other properties. For each layer of build material, portions may be selected for application of agent (e.g. fusing and/or detailing agent) such that a layer or slice of the parts may be formed. Each portion may in some examples, correspond to a voxel in the virtual representation, though in other examples there may not be a one-to-one mapping of voxels to portions of build material.

Each portion of build material to which agent is applied may be attributed to a particular part. In this way, the use of agents and build material may be attributed to particular parts, and hence the monitoring component 104 can, for a particular part, monitor a total amount of agent and/or build material used to create that part. In some examples, the unique identifier given to each part is a Universally Unique Identifier (UUID). In some examples, where agents are applied to portions of build material that do not form portions of completed objects or parts, such as where detailing agent is used, the use of such agents may be attributed to the nearest object.

FIG. 2 is a schematic drawing of an example of a device 200 such as for example an additive manufacturing device, or a 3D printer. The device 200 comprises an execution component 202 to execute an additive printing task to create a first article and a second article, and a monitoring component 204 to, during execution of the additive printing task, monitor a quantity of consumable resources used to create the first article. In some examples, the execution component 202 is to create the first article and the second article by applying agents (e.g. print agent and/or detailing agent) to layers of build material and processing the layers to form the first article and the second article. In some examples, the agents include agents, such as detailing agent, applied to areas of the layers of build material that are not included within completed articles.

The print agent may include, for example, fusing agent and/or detailing agent, and thus may in some examples include print agent (such as detailing agent) applied to portions of build material that may not form part of the finished first article. In some examples, the monitoring component 204 is to monitor the quantity of consumable resources used to create the first article by estimating an amount of build material comprised in the first article and/or measuring an amount of print agent used to create the first article. In some examples, the monitoring component 204 is to monitor the quantity of consumable resources used to create the first article by measuring an amount of print agent (e.g. detailing agent) applied to portions of build material that are not comprised in the first article and are not comprised in the second article.

The device 200 also includes a communication component 206 to provide an estimate of the quantity of consumable resources used to create the first article following completion of creation of the first article. The estimate may be provided to, for example, a user or a computing device. In some examples, the communication component 206 is to receive a request from a computing device, and to provide the estimate to the computing device in response to the request.

In some examples, the communication component 206 may provide a “web-style” interface for communication between the device 200 and a user or the user's computing device. For example, the user may request the indication of the quantity of consumable resources used to create the first article by sending a Uniform Resource Locator (URL) or Uniform Resource Identifier (URI) to the device 200. In some examples, the request may identify the first article. For example, the request may comprise a URL that contains a UUID identifying the first article. The device may then respond with a file such as for example a HTML file, XML file or the like that provides the indication. If the request is made after the additive manufacturing process is complete, the indication may indicate the total quantity of consumable resources used to create the first article. If the request is made during the additive manufacturing process, the indication may indicate the total quantity used to create the first article up to the point the request was received by the device 200, e.g. a cumulative total.

The request may identify the “job” (e.g. additive printing task, additive printing instruction file, etc) as well as the article. This may be useful when the additive printing device stores multiple jobs. Each job may be given a unique identifier such as a UUID. Therefore, in some examples, a URL request may take the form: http://<device_IP_address>/<job_UUID>/<article_UUID>/status. Another example may be https://<printerIP>/HP-MJF/Pl/1.0/jobs/<jobUUID>/parts/<articleUUID>/status. The device may then return information relating to the identified article in the identified job. The URL may take on any other suitable form and/or may include an indication of the information that is requested. The information returned from the device can be, for example, a XML file, HTML file or any other suitable format.

In some examples, the monitoring component 204 is to monitor a quantity of consumable resources used to create the second article during execution of the additive printing task. Therefore, for example, a quantity of consumable resources used to create each of multiple articles may be monitored, and an indication of the quantity for any one or more of the articles may be provided by the device 200.

In some examples, communication component 206 can provide other information. For example, the communication component can provide other information relating to an article, such as for example a preview image of the article, an estimated time left before completion of creation of the article, and/or any other suitable information. As indicated above, a request such a for example a URL may indicate the information that is being sought.

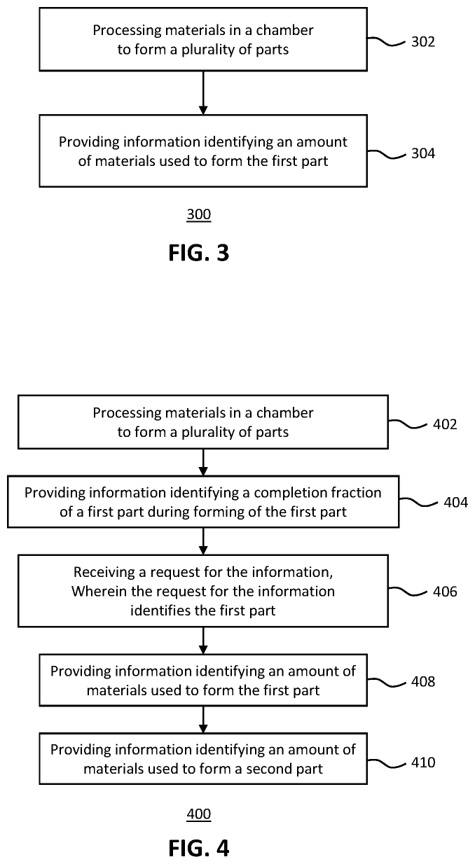

FIG. 3 is a flow chart of an example of a method 300 such as for example an additive manufacturing method. The method 300 comprises, in block 302, processing materials in a chamber to form a plurality of parts, for example in an additive manufacturing process or task. The method 300 also comprises, in block 304, providing information identifying a measure of materials used to form the first part. As such, the information may be used to determine, for example, a cost of materials used to produce the first part such as, for example build material and/or agents such as solidifying agent (e.g. fusing agent), detailing agent and/or other agents to change the properties of a portion of the first part. The properties may include for example colour, texture, elasticity, electrical conductivity, odour and/or another property of the portion of the first part. Some print agents may have multiple functions. For example, an agent may provide both a solidifying function and a colour property to build material.

FIG. 4 is a flow chart of an example of a method 400 such as for example an additive manufacturing method. The method 400 comprises, in block 402, processing materials in a chamber to form a plurality of parts (e.g. at least a first part and a second part), for example in an additive manufacturing process or task. The method 400 also comprises, in block 404, providing information identifying a completion fraction of a first part of the plurality of parts during forming of the first part. The information may be provided before completion of the process. The information may identify, for example, the percentage completion of the first part. Additionally or alternatively, the information may identify, for example, a measure of materials used in creation of the first part so far during the process.

The method 400 comprises, in block 406, receiving a request for the information, wherein the request for the information identifies the first part, and in block 408, in response, providing information identifying a measure of materials used to form the first part. As indicated above, the request may be for example in the form of a web-style request such as a URL or URI that identifies the first part, and the information may be provided in the form of for example an XML file, HTML file or similar.

The method 400 comprises, in block 410, providing information identifying a measure of materials used to form a second part of the plurality of parts. This information may be provided for example in response to a request that identifies the second part.

The materials used can be measured in any suitable manner. In some examples, the number of drops of each agent that will be deposited into each portion of a layer of build material is determined, for example from the intended properties (e.g. solidification, colour, electrical conductivity and so on). This can be determined by the apparatus performing an additive manufacturing process, for example, or by some other entity. During the additive manufacturing process, the apparatus may count the number of drops of each agent applied to each portion of build material. Then, the number of drops may be multiplied by the average volume of the drops. The average volume may be reported, for example, by a printhead controller that dispenses the drops. As a result, the total amount of millilitres consumed to create each individual object or part may be calculated, by attributing each portion of build material to which one or more agents are applied to a particular object or part.

In a particular example, an apparatus (e.g. printing apparatus) may use three components during the creation of an object. These are: the build material, the detailing agent and the solidification agent (e.g. fusing agent or binding agent). In a volumetric representation of the parts to be printed (which may be for example a virtual representation of the parts), the volume of each layer of each part that will be created is known, as each layer has a particular thickness. The volume of a layer of build material in the build chamber is also known, from the thickness of each layer and the dimensions of the build chamber. As such, the proportion of the layer of build material that will be solidified to generate the parts can be determined. The apparatus may also know the density of the layers of build material placed in the print bed. This property may vary from layer to layer, but in some examples, on average, the variations substantially cancel out. The mass of the build material comprised within each created object can therefore be determined. As the amount of agent used to create the objects can also be determined, for example by using any of the examples described herein, the total amount of materials (build material and agents) used to create each object can be measured. In some examples, the amount of materials used to create any one or all of the created objects can be determined.

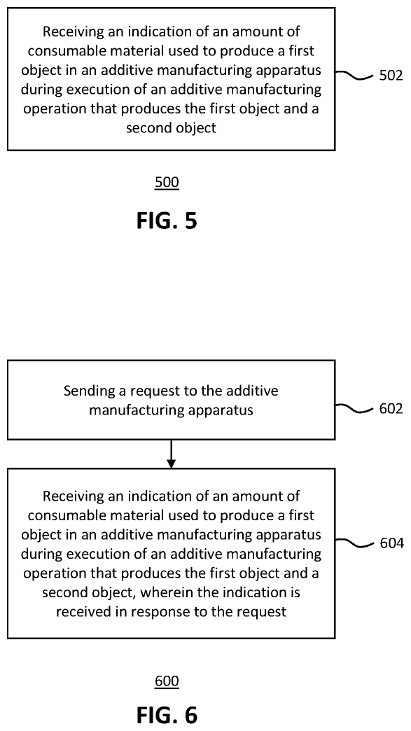

FIG. 5 is a flow chart of an example of a method 500 such as for example an additive manufacturing method. The method 500 may be carried out, for example, on a computing device used to communicate with an additive manufacturing apparatus (e.g. operated by a user), or on a processing component of an additive manufacturing apparatus. The method 500 comprises, in block 502, receiving an indication of an amount of consumable material used to produce a first object in an additive manufacturing apparatus during execution of an additive manufacturing operation that produces the first object and a second object.

FIG. 6 is a flow chart of an example of a method 600 such as for example an additive manufacturing method. The method 600 may be carried out, for example, on a computing device used to communicate with an additive manufacturing apparatus (e.g. operated by a user). The method 600 comprises, in block 602, sending a request to the additive manufacturing apparatus, and in block 604, receiving an indication of an amount of consumable material used to produce a first object in an additive manufacturing apparatus during execution of an additive manufacturing operation that produces the first object and a second object, wherein the indication is received in response to the request. Therefore, in some examples, a user may for example use a computing device to request information from the additive manufacturing apparatus as to how much consumable material has been used to create a particular object (the first object) in an additive manufacturing process or task.

Examples disclosed herein may refer to print agent and/or detailing agent. However, in any of the above examples, other agents may be applied or used in addition or as alternatives.

Examples in the present disclosure can be provided as methods, systems or machine readable instructions, such as any combination of software, hardware, firmware or the like. Such machine readable instructions may be included on a computer readable storage medium (including but is not limited to disc storage, CD-ROM, optical storage, etc.) having computer readable program codes therein or thereon.

The present disclosure is described with reference to flow charts and/or block diagrams of the method, devices and systems according to examples of the present disclosure. Although the flow diagrams described above show a specific order of execution, the order of execution may differ from that which is depicted. Blocks described in relation to one flow chart may be combined with those of another flow chart. It shall be understood that each flow and/or block in the flow charts and/or block diagrams, as well as combinations of the flows and/or diagrams in the flow charts and/or block diagrams can be realized by machine readable instructions.

The machine readable instructions may, for example, be executed by a general purpose computer, a special purpose computer, an embedded processor or processors of other programmable data processing devices to realize the functions described in the description and diagrams. In particular, a processor or processing apparatus may execute the machine readable instructions. Thus functional modules of the apparatus and devices may be implemented by a processor executing machine readable instructions stored in a memory, or a processor operating in accordance with instructions embedded in logic circuitry. The term ‘processor’ is to be interpreted broadly to include a CPU, processing unit, ASIC, logic unit, or programmable gate array etc. The methods and functional modules may all be performed by a single processor or divided amongst several processors.

Such machine readable instructions may also be stored in a computer readable storage that can guide the computer or other programmable data processing devices to operate in a specific mode.

Such machine readable instructions may also be loaded onto a computer or other programmable data processing devices, so that the computer or other programmable data processing devices perform a series of operations to produce computer-implemented processing, thus the instructions executed on the computer or other programmable devices realize functions specified by flow(s) in the flow charts and/or block(s) in the block diagrams.

Further, the teachings herein may be implemented in the form of a computer software product, the computer software product being stored in a storage medium and comprising a plurality of instructions for making a computer device implement the methods recited in the examples of the present disclosure.

While the method, apparatus and related aspects have been described with reference to certain examples, various modifications, changes, omissions, and substitutions can be made without departing from the spirit of the present disclosure. It is intended, therefore, that the method, apparatus and related aspects be limited only by the scope of the following claims and their equivalents. It should be noted that the above-mentioned examples illustrate rather than limit what is described herein, and that those skilled in the art will be able to design many alternative implementations without departing from the scope of the appended claims.

The word “comprising” does not exclude the presence of elements other than those listed in a claim, “a” or “an” does not exclude a plurality, and a single processor or other unit may fulfil the functions of several units recited in the claims.

The features of any dependent claim may be combined with the features of any of the independent claims or other dependent claims.

1. A device comprising:
an execution component to execute an additive printing task to create a first article and a second article; and
a monitoring component to, during execution of the additive printing task, monitor a quantity of consumable resources used to create the first article.

2. The device of claim 1, wherein the monitoring component is to monitor the quantity of consumable resources used to create the first article by estimating an amount of build material comprised in the first article and/or measuring an amount of print agent used to create the first article.

3. The device of claim 1, wherein the monitoring component is to monitor the quantity of consumable resources used to create the first article by measuring an amount of print agent applied to portions of build material that are not comprised in the first article and are not comprised in the second article.

4. The device of claim 3, wherein the print agent applied to portions of build material that are not comprised in the first article and are not comprised in the second article comprises detailing agent.

5. The device of claim 1, wherein the monitoring component is to monitor a quantity of print agent and detailing agent used to create the first article.

6. The device of claim 1, comprising a communication component to provide an estimate of the quantity of consumable resources used to create the first article following completion of creation of the first article.

7. The device of claim 1, wherein the monitoring component is to monitor a quantity of consumable resources used to create the second article during execution of the additive printing task.

8. The device of claim 1, wherein the execution component is to create the first article and the second article by applying print agent and detailing agent to layers of build material and processing the layers to form the first article and the second article.

9. A method comprising:
processing materials in a chamber to form a plurality of parts; and
providing information identifying an amount of materials used to form a first part of the plurality of parts.

10. The method of claim 9, comprising providing information identifying a measure of materials used to form a second part of the plurality of parts.

11. The method of claim 9, comprising receiving a request for the information, wherein the request for the information identifies the first part and the information is provided in response.

12. The method of claim 9, comprising providing information identifying a completion fraction of the first part during formation of the first part.

13. The method of claim 9, wherein processing materials in the chamber to form the plurality of parts comprises depositing print agent and detailing agent on a layer of powder in the chamber, and wherein the information identifying an amount of materials used to form the first part includes information identifying an amount of fusing agent and detailing agent used to form the first part.

14. A method comprising:
receiving an indication of an amount of consumable material used to produce a first object in an additive manufacturing apparatus during execution of an additive manufacturing operation that produces the first object and a second object.

15. The method of claim 14, comprising sending a request identifying the first object to the additive manufacturing apparatus, wherein the indication is received in response to the request.
